(19) United States
(12) Patent Application Publication
(10) Pub. No.: US 2009/0138530 A1
(43) Pub. Date: May 28, 2009

(54) Data management method for logical volume manager

(75) Inventors: Hai-Ting Yao, Tianjin (CN); Jian-Zhong Wang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/984,965

(22) Filed: Nov. 26, 2007

(51) Int. Cl. G06F 12/00

(52) U.S. Cl. 707/204

(57) ABSTRACT

A data management method for logical volume manager (LVM), called LVM includes a first type of physical volume and a second type of physical volume. Access speed of the first type of physical volume is higher than that of the second type of physical volume. Each physical volume has a plurality of physical extents, and a data storage method includes the following steps. Obtaining access frequencies of all the physical extents in statistics; performing a data migration operation, migrating and saving data in the physical extents satisfying an access frequency threshold value in the second type of physical volume to the physical extents without any data in the first type of physical volume; and rewriting a corresponding physical extent number for the migrated data.

### BACKGROUND OF THE INVENTION

1. Field of Invention

The present invention relates to a data management method for a logical volume manager (LVM). More particularly, the present invention relates to a method capable of migrating data to high-speed physical volume or low-speed physical volume according to access frequency of physical extents in the LVM.

2. Related Art

In order to safely and effectively save digital data in computers, many digital data storage technologies have been proposed in the past, such as redundant array of independent disks (RAID), and logical volume manager (LVM). For the LVM, a plurality of physical volumes is integrated to be regarded as a same volume group, and then the volume group is partitioned into several logical volumes (LV). Data storage units in each LV are physical extents, and size of the physical extents can be changed according to practical operation of the LVM.

Each physical extent has a unique physical extent number. When the LVM performs data writing, the physical extent numbers are recorded. When the LVM intends to read the data, it is only necessary to get the data stored therein in sequence according to the physical extent numbers.

When writing data into the LV, the LVM may allocate and save the data to be written to different physical extents. Referring to FIG. 1, a schematic view of data saving of a conventional LVM is shown. FIG. 1 shows an LV 100, a first type of physical volume 110, a second type of physical volume 120 and physical extents 111. The LV 100 includes a plurality of physical volumes. Each physical volume includes a plurality of physical extents 111. Each data may be cut and saved in different physical extents 111. It is shown in FIG. 1 that the same LV 100 has different physical volumes, and here it is assumed that the LV 100 has the first type of physical volume 110 and the second type of physical volume 120. Access speed of the first type of physical volume 110 is higher than that of the second type of physical volume 120. In FIG. 1, the physical extents 111 filled with slash regions represent the data is saved therein.

Although the LVM can integrate a plurality of physical volumes to become a large-scale physical volume, the access speeds of various types of physical volumes are different, such that the data accessing may be affected because of the access speed of the physical volumes. However, the LVM arranges the data in the physical extents 111 in a random saving manner, so the saving is not performed directing to the physical volumes with different access speeds.

In other words, if the physical extent 111 with high access frequency is placed in the second type of physical volume 120, the access performance on the physical extent 111 performed by the LVM may be reduced. On the contrary, if the physical extent 111 with low access frequency is placed in the first type of physical volume 110, although the access speed is quick, the whole access performance of the LVM may be lowered.

### SUMMARY OF THE INVENTION

In view of the above problem, the present invention is mainly directed to provide a data management method for an LVM. The LVM includes a first type of physical volume and a second type of physical volume, and each physical volume has a plurality of physical extents.

In order to achieve the objective, the data management method for the LVM provided by the present invention includes the following steps: obtaining access frequencies of all the physical extents in the first type of physical volume and the second type of physical volume in statistics; setting an access frequency threshold value; migrating data in the physical extents satisfying the access frequency threshold value in the second type of physical volume to the first type of physical volume.

In the present invention, data storage and saving are performed according to access speed of each physical volume and access frequency of each physical extent in the LVM, so as to enhance the data access speed of the LVM.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of data saving of a conventional LVM;

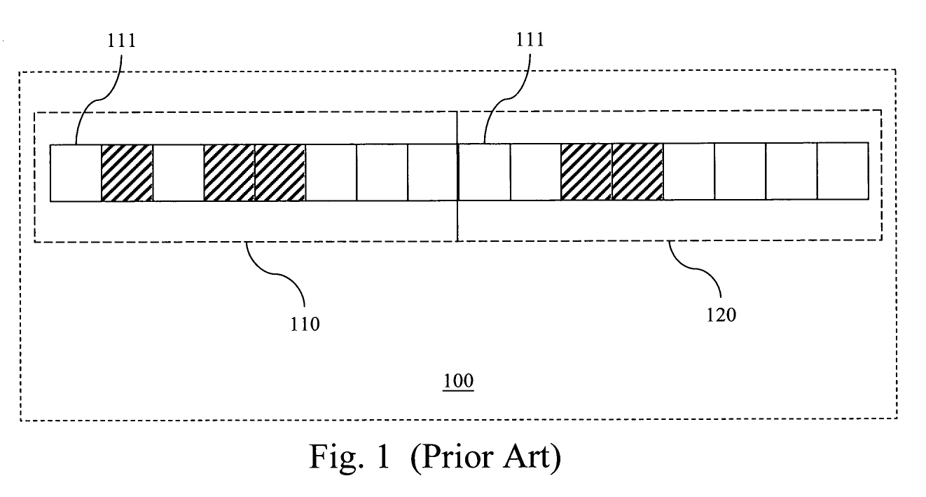

FIG. 2 is a flow chart of data storage operation of the LVM according to the present invention;

FIG. 3 is a flow chart of access frequency setting operation of the present invention;

FIG. 4A is a schematic view of migrating data in the physical extent in this embodiment;

FIG. 4B is a schematic view of migrating data in the physical extent in this embodiment;

FIG. 5A is a schematic view of determining the quantity of the migrated physical extents in this embodiment; and

FIG. 5B is a schematic view of determining the quantity of the migrated physical extents in this embodiment.

### DETAILED DESCRIPTION OF THE INVENTION

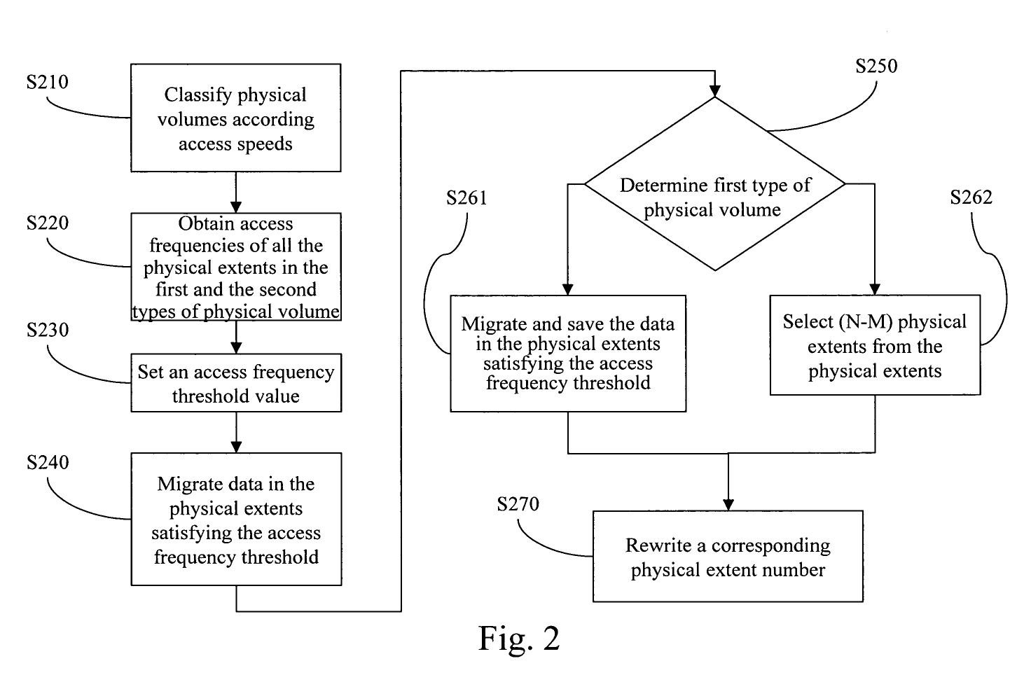

Referring to FIG. 2, a flow chart of data storage operation of the LVM according to the present invention is shown. Architecture of an LV 400 is the same as that mentioned above, so it is not described here. First, physical volumes in the LVM are classified according to access speeds thereof (step S210). In the present invention, according to the access speed of the physical volume, the physical volumes are classified into a first type of physical volume 410 and a second type of physical volume 420. Definitely, the physical volumes can also be classified into different speed levels. The access speed of the first type of physical volume 410 is higher than that of the second type of physical volume 420. The access frequencies of all the physical extents in the first type of physical volume and the second type of physical volume are obtained in statistics (step S220).

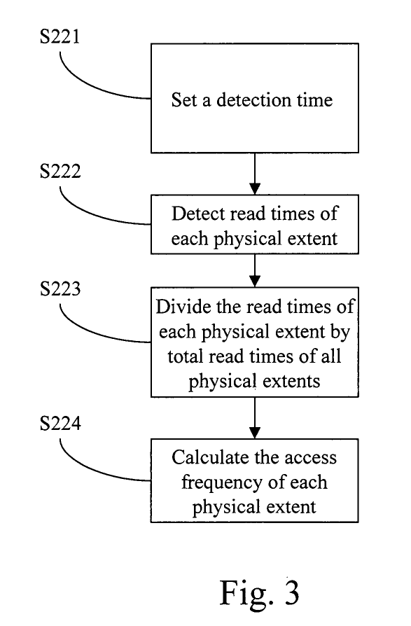

For the setting of the access frequency in the present invention, please refer to FIG. 3. A detection time is set (step S221), the detection time can be one hour, one day, or one week, which is set according to the operation of the LVM. Read times of each physical extent is detected (step S222). The read times of each physical extent is divided by total read times of all the physical extents (step S223). The access frequency of each physical extent is calculated (step S224).

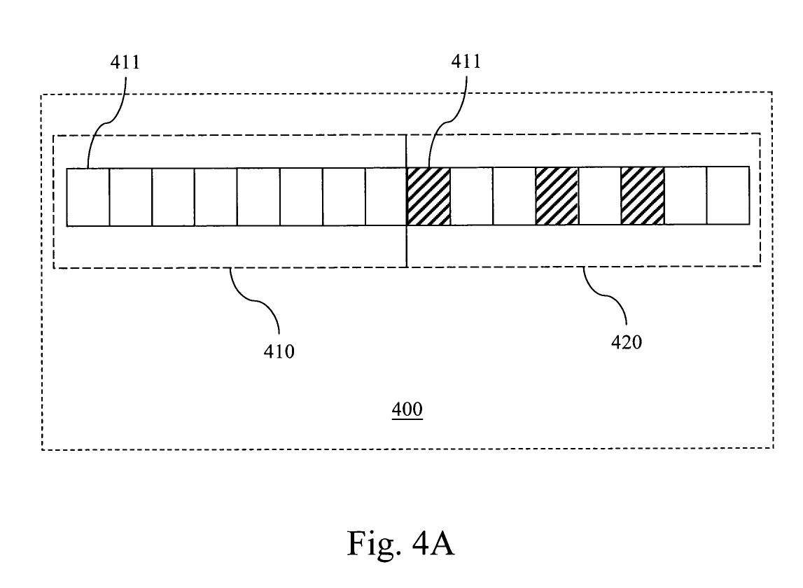

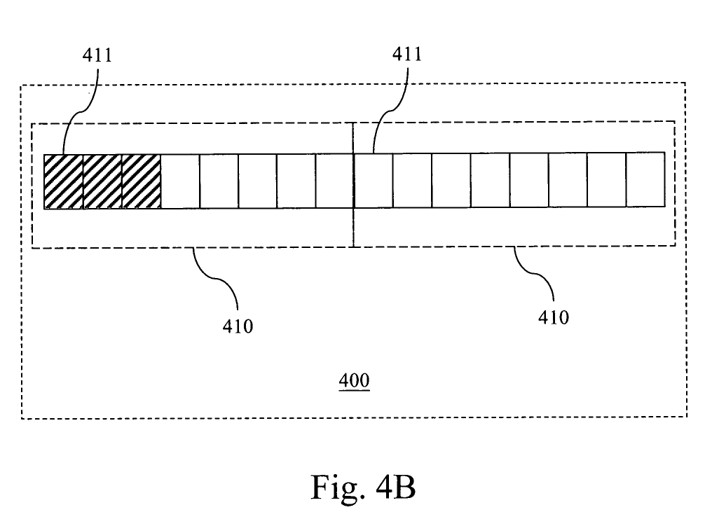

Referring to FIGS. 4A and 4B, schematic views of migrating data in the physical extent in this embodiment are shown. An access frequency threshold value is set (step S230). Data in the physical extents satisfying the access frequency threshold value in the second type of physical volume is migrated to the physical extents have no data saved in the first type of physical volume (step S240). In FIG. 4B, the physical extents 411 filled up with slash regions represent that data is saved therein.

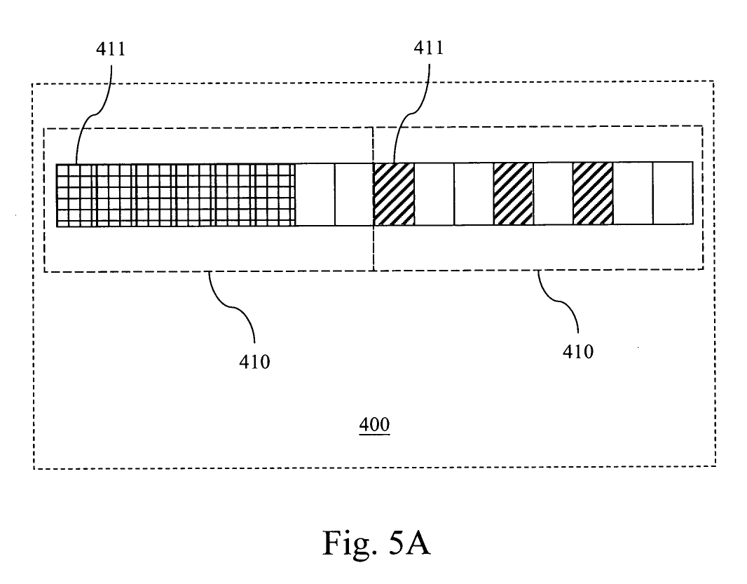

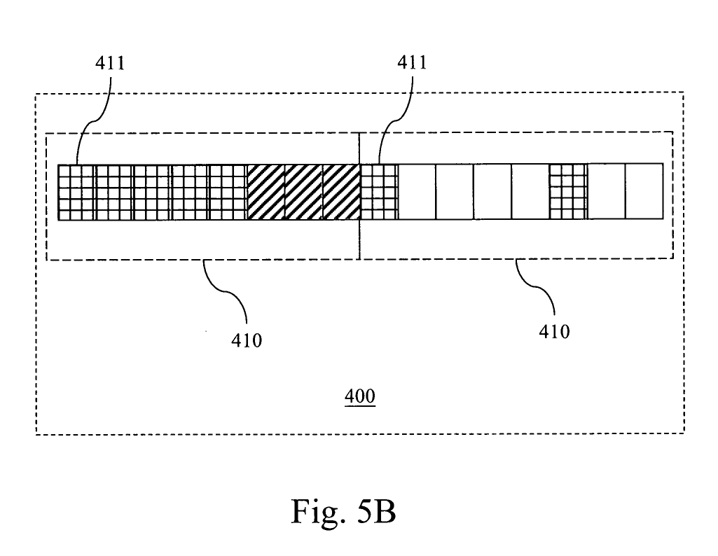

Next, it is determined whether the first type of physical volume has enough physical extents (step S250). Referring to FIG. 5A, if the quantity (it is assumed to be N, the physical extents 411 filled up with slash regions are respectively used to represent that data is saved therein) of the physical extents 411 requiring to be migrated in the second type of physical volume 420 is smaller than the quantity (it is assumed to be M, the physical extents 411 filled up with vertical line regions are respectively used to represent that data is saved therein) of the physical extents 411 have no data saved in the first type of physical volume 410, data in the physical extents 411 satisfying the access frequency threshold value in the second type of physical volume 420 is migrated and saved into the physical extents 411 of the first type of physical volume 410 (step S261). The setting of the access frequency threshold value is determined according to the access frequencies of all the physical extents. For example, for the access frequencies of all the physical extents 411, the first 40% are set to be the corresponding access frequency threshold value. Therefore, for the physical extents 411 with the access frequencies satisfying the first 40% in the second type of physical volume 420, data is migrated and saved into the physical extents 411 have no data saved in the first type of physical volume 410.

Referring to FIG. 5B, if the quantity (it is assumed to be N, and the physical extents 411 filled up with the vertical line regions represent that the data is saved therein) of the physical extents 411 requiring to be migrated in the second type of physical volume is larger than the quantity (It is assumed to be M, and blank regions represent that no data is saved in the physical extents 411) of the physical extents 411 have no data saved in the first type of physical volume 410, (N-M) physical extents are selected from the physical extents have data saved in the first type of physical volume (step S262). The (N-M) physical extents 411 with the lowest access frequency in the first type of physical volume 410 are ordered, and data in those physical extents 411 is migrated and saved into the physical extents 411 of the second type of physical volume 420. Then, data in the physical extents 411 satisfying the access frequency threshold value in the second type of physical volume 420 is migrated to the first type of physical volume 410, thereby assuring that the first type of physical volume 410 has enough physical extents for saving the data.

During the migration of a physical extent 411, if a user intends to rewrite the data of the physical extent 411, the LVM firstly suspends the data rewriting action on the physical extent 411, and performs the rewriting action until the data migration of the physical extent 411 is finished. Each physical extent 411 is not quite large, so the time for migrating the physical extent 411 does not seriously affect the access efficiency of the LVM.

Finally, a corresponding physical extent number is rewritten for the migrated data (step S270). Data in the LVM is respectively stored in different physical extents 411, so each physical extent 411 has a unique physical extent number. The LVM finds out the data to be read according to the physical extent numbers, so after the data is migrated from the second type of physical volume 420 to the first type of physical volume 410, it is necessary for the LVM to update and record new physical extent numbers.

In the present invention, after the physical extents in the second type of physical volume 420 are migrated to the physical extents 411 in the first type of physical volume 410, the physical extent numbers formerly recorded in the LVM are modified at the same time, thereby ensuring the completeness of data reading.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data management method for a logical volume manager (LVM), wherein the LVM comprises a first type of physical volume and a second type of physical volume, each physical volume has a plurality of physical extents, access speed of the first type of physical volume is higher than that of the second type of physical volume, and the data management method comprises:
obtaining access frequencies of all the physical extents in statistics;
performing a data migration operation, migrating and saving data in the physical extents satisfying an access frequency threshold value in the second type of physical volume to the physical extents of the first type of physical volume; and
rewriting a corresponding physical extent number for the migrated data.

2. The data management method for an LVM as claimed in claim 1, wherein setting the access frequency further comprises:
setting a detection time;
detecting read times of each physical extent;
dividing the read times of each physical extent by total read times of all the physical extents; and
calculating the access frequency of each physical extent.

3. The data management method for an LVM as claimed in claim 1, further comprising: if a quantity N of the physical extents requiring to be migrated in the second type of physical volume is larger than a quantity M of the physical extents have no data saved in the first type of physical volume, selecting (N-M) physical extents from the physical extents have data saved in the first type of physical volume.

4. The data management method for an LVM as claimed in claim 1, wherein selecting the physical extents of the first type of physical volume further comprises: ordering (N-M) physical extents with the lowest access frequency in the first type of physical volume.

5. The data management method for an LVM as claimed in claim 1, wherein each physical extent has a unique physical extent number, the LVM reads data stored in the physical extent according to the physical extent number.

6. The data management method for an LVM as claimed in claim 1, wherein migrating and saving data to the physical extents of the first type of physical volume further comprises: migrating and saving data in the physical extents satisfying an access frequency threshold value in the second type of physical volume to the physical extents have no data saved in the first type of physical volume.

7. The data management method for an LVM as claimed in claim 1, wherein setting the access frequency threshold value comprises:
ordering the access frequencies of all the physical extents; and
setting the access frequency threshold value, for selecting the physical extents satisfying the access frequency threshold value.
